(19) United States
(12) Patent Application Publication
(10) Pub. No.: US 2013/0287301 A1
(43) Pub. Date: Oct. 31, 2013

(54) IMAGE PROCESSING APPARATUS, IMAGE PROCESSING METHOD, AND IMAGE PROCESSING PROGRAM

(71) Applicant: JVC KENWOOD Corporation, Yokohama-shi (JP)

(72) Inventors: Shin NAKATE, Yokohama-shi (JP); Wataru INOHA, Yokohama-shi (JP)

(21) Appl. No.: 13/898,765

(22) Filed: May 21, 2013

(30) Foreign Application Priority Data
Nov. 22, 2010 (JP) 2010-259993

(51) Int. Cl. G06K 9/62

(52) U.S. Cl. CPC G06K 9/6267
USPC 382/190

(57) ABSTRACT

A feature analysis unit acquires feature data representing the features of each scene in image information. A group classification unit classifies a group composed of plural scenes to any one of a plurality of group types based on the feature data. A cut determination unit determines cuts from the scenes based on the importance calculated from the feature data using a formula corresponding to the group type of the group. A digest reproduction unit reproduces the cuts.

### CROSS REFERENCES TO RELATED APPLICATION

This application is a Continuation of PCT Application No. PCT/JP2011/075497, filed on Nov. 4, 2011, and claims the priority of Japanese Patent Application No. 2010-259993, filed on Nov. 22, 2010, the entire contents of both of which are incorporated herein by reference.

### BACKGROUND ART

The embodiment relates to an image processing apparatus, an image processing method, and an image processing program to create a digest of image data.

In order to find an image that a user wants to watch from large quantities of image data stored on devices, the intended image can be searched for by high-speed reproduction of image, for example. However, this requires a large amount,of time and effort. Accordingly, devices configured to select a predetermined number of high-priority scenes and create and reproduce a digest of image data (an image summary) have been proposed for understanding the outline of the contents of the image data.

Examples of the proposed devices are: a device which gives a priority to each scene and selects a predetermined number of high-priority scenes to form a digest of image contents (see Japanese Patent Laid-open Publication No. 2008-227860); and a device which is capable of creating and reproducing a digest image by properly extracting characteristic sections, that is, sections important for the program according to the genre of the program such as news, drama, or music (see Japanese Patent publication No. 4039873).

### SUMMARY

With the technique described in Japanese Patent Laid-open Publication No. 2008-227860, a priority is given to every scene based on the same standard. However, important or characteristic portions (scenes) which are key parts of the image and the user wants to watch, depend on the contents of the image.

Moreover, the method described in Japanese Patent Publication No. 4039873 gives genre information acquired from an electronic program guide (EPG) to each scene and extracts characteristic sections according to the genre. The method therefore requires a means of giving the genre information.

An object of the present invention is to provide an image processing device, an image processing method, and an image processing program which are capable of efficiently creating a digest for each type of image with a simple structure.

In order to achieve the aforementioned objective, an aspect of the present invention is an image processing apparatus including: a feature analysis unit configured to acquire feature data from image included in each of a plurality of scenes which is continuous image information from the start to the end of shooting, the feature data representing the features of the scenes; a group classification unit configured to classify a group as a set of scenes taken from the plurality of scenes into any one of a plurality of group types based on the feature data of the scenes included in the group; a cut determination unit configured to calculate importance from the feature data of the scenes included in the group using a formula corresponding to the group type to which the group is classified and determine cuts from the group based on the importance, the cuts being image to be reproduced; and a digest reproduction unit configured to reproduce the cuts.

### BRIEF DESCRIPTION OF THE DRAWINGS

FIG. 1 is a schematic block diagram for explaining the basic configuration of an image processing apparatus according to the embodiment.

FIG. 2 is a schematic view explaining representative frames used in the image processing apparatus according to the embodiment.

FIG. 3 is an example illustrating a frame and explaining feature data used in the image processing apparatus according to the embodiment.

FIG. 4 is an example showing group classification information used in the image processing apparatus according to the embodiment.

FIG. 5 is a schematic block diagram for explaining a cut determination unit of the image processing apparatus according to the embodiment.

FIGS. 6A to 6E are views for explaining processing by a reference frame determination unit of the image processing apparatus according to the embodiment.

FIGS. 7A to 7D are views for explaining processing by a cut section determination unit of the image processing apparatus according to the embodiment.

FIG. 8 is a flowchart explaining an image processing method according to the embodiment.

FIG. 9 is a flowchart for explaining processing by the cut determination unit in the image processing method according to the embodiment.

### DETAILED DESCRIPTION

Next, a description is given of the embodiment with reference to the drawings. In the following description of the drawings, the same or similar portions are given the same or similar reference numerals. The following embodiment shows an apparatus and a method to embody the technical idea of the present invention and a program used in the apparatus by way of example. The technical idea of the present invention is not specified by the apparatus and method and the programs used by the apparatus shown in the example embodiment. The technical idea of the present invention can be variously changed within the technical scope described in the claims.

### (Image Processing Apparatus)

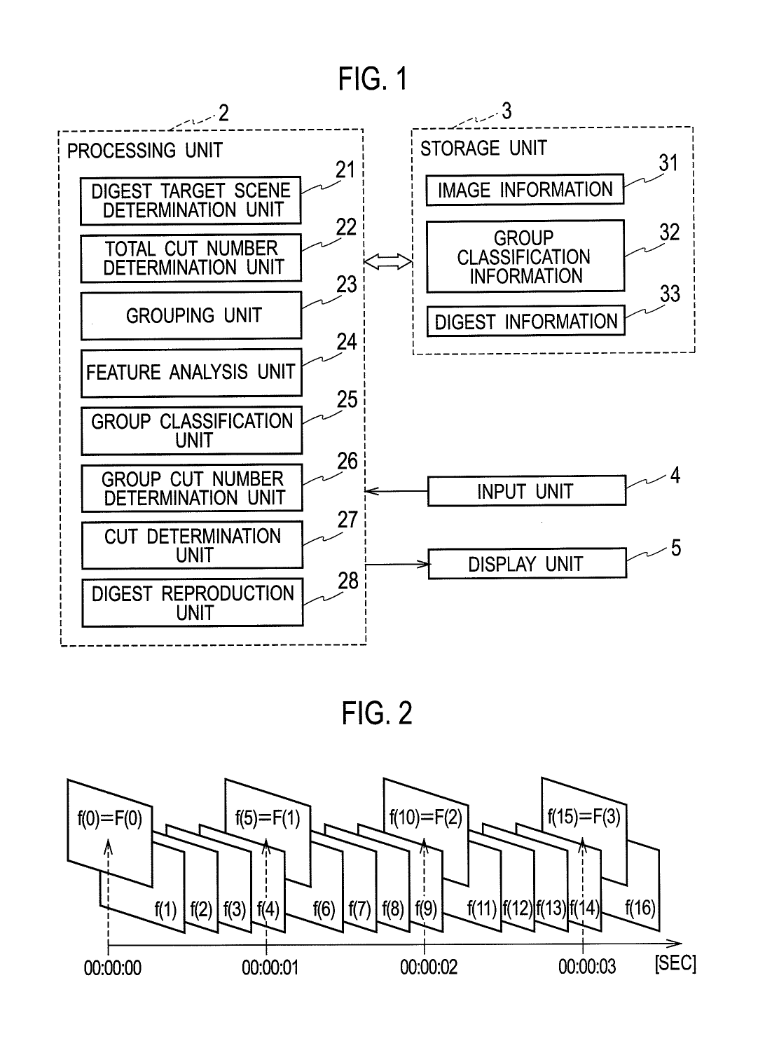

As shown in FIG. 1, an image processing apparatus according to the embodiment includes: a processing unit 2 which performs various operations of the image processing apparatus according to the embodiment; a storage unit 3 storing various data including program files and moving image files; an input unit 4 inputting signals such as signals from the outside to the processing unit 2; and a display unit 5 displaying various images and the like. The image processing apparatus according to the embodiment can have a hardware configuration of a von Neumann-type computer.

The storage unit 3 stores: image information 31 including image data formed of the image itself and various information associated with the image; group classification information 32 used to classify image data and separate it into each group; and digest information 33 which defines sections to be reproduced as a digest which is an image summary. Moreover, the storage unit 3 is configured to store a series of programs necessary for processing performed by the image processing apparatus according to the embodiment and is used as a temporary storage area necessary for the processing. The programs could be stored in a non-transitory computer-readable recording medium executed by a computer.

The image information 31, group classification information 32, digest information 33, and the like being stored in the storage unit 3 are a logical representation, and the image information 31, group classification information 32, digest information 33, and the like may be actually stored on a range of hardware devices. For example, information such as the image information 31, group classification information 32, and digest information 33 could be stored on a main storage device composed of volatile storage devices such as SRAM and DRAM and an auxiliary storage device composed of non-volatile devices including a magnetic disk such as a hard disk (HD), a magnetic tape, an optical disk, and a magneto-optical disk. In addition, the auxiliary storage devices could include a RAM disk, an IC card, a flash memory card, a USB flash memory, a flash disk (SSD), and the like.

The input unit 4 is composed of input devices such as various types of switches and connectors through which signals outputted from external devices such as an image shooting device and an image reproducing device are inputted. The display unit 5 is composed of a display device and the like. The input unit 4 and display unit 5 may be composed of a touch panel, a light pen, or the like as applications of the input device and display device.

The processing unit 2 includes: a digest target scene determination unit 21, a total cut number determination unit 22, a grouping unit 23, a feature analysis unit 24, a group classification unit 25, a group cut number determination unit 26, a cut determination unit 27, and a digest reproduction unit 28 as a logical representation.

The digest target scene determination unit 21 determines digest target scenes from the information from the input unit 4 as part of the process of creating a digest from plural scenes. The digest target scenes are candidate scenes that can be employed in the digest. The digest target scenes may be selected from plural scenes one by one by the user's operation or may include two scenes selected by the user and all the scenes between the two selected scenes. Alternatively, the digest target scenes may include scenes shot on the dates or during the time periods specified by the user's operation. In this embodiment, a scene refers to continuous image data sectioned between the start and the end of a shooting operation in the process of shooting image.

The total cut number determination unit 22 determines a total number Ac of cuts which is the total number of cuts to be reproduced as a digest from the digest target scenes. In this embodiment, a cut refers to a section of image data to be reproduced as the digest of a scene.

The total number Ac of cuts may be directly specified by the information from the input unit 4 or may be calculated from a specific required length of the total time period of the digest. In the case of determining the total number Ac of cuts from the required length of the digest, the total cut number determination unit 22 may calculate the total number Ac of cuts based on a previously set average time of cuts. For example, when the average time of cuts is set to 10 seconds and the digest length is set to 180 sec, the total number Ac of cuts is 18 cuts (Ac=180/10=18). Alternatively, the required digest length may be automatically calculated by the total cut number determination unit 22 based on a parameter which is set in advance based on information including the total time period of the digest target scenes and the like.

The grouping unit 23 performs grouping to divide the plural digest target scenes determined by the digest target scene determination unit 21 into some groups. For example, the grouping unit 23 first arranges the plural digest target scenes in chronological order of shooting dates and times and then divides the arranged plural digest target scenes in descending order based on the shooting intervals between the plural digest target scenes. Alternatively, the grouping unit 23 calculates the total number of group to use based on previously determined evaluation points, thresholds of various evaluation points and changes in evaluation points, and the like. The evaluation points include the total time period of scenes included in each group, the shooting intervals of the scenes, or the average of shooting intervals.

The feature analysis unit 24 performs a process to acquire the feature data using the features of each digest target scene. The feature data are frame feature data representing features of plural representative frames selected from the entire frame set as static images constituting each scene. The representative frames are set by selecting frames recorded at 1 second intervals. To be specific, as shown in FIG. 2, in a scene composed of frames f(0) to f(16) recorded in sequence, the feature analysis unit 24 respectively sets the representative frames F(0), F(1), F(2), and F(3) to the first frame f(0), frame f(5), frame f(10), and frame f(15), which are recorded 0, 1, 2, and 3 seconds after the start of recording, respectively, and acquires the feature data from the representative frames F(0) to F(3).

The frame feature data as the feature data which can be acquired from each representative frame F(i) (i=0, 1, 2 . . . ) can include: Num(F(i)) indicating the number of faces displayed in the representative frame F(i); Dis(F(i)) indicating the distance between the center of the face which is the largest among the faces displayed in the representative frame F(i) and whichever corner of the frame is closest to the largest face; Siz(F(i)) indicating the size of the largest face largest among the faces displayed in the representative frame F(i); or the like.

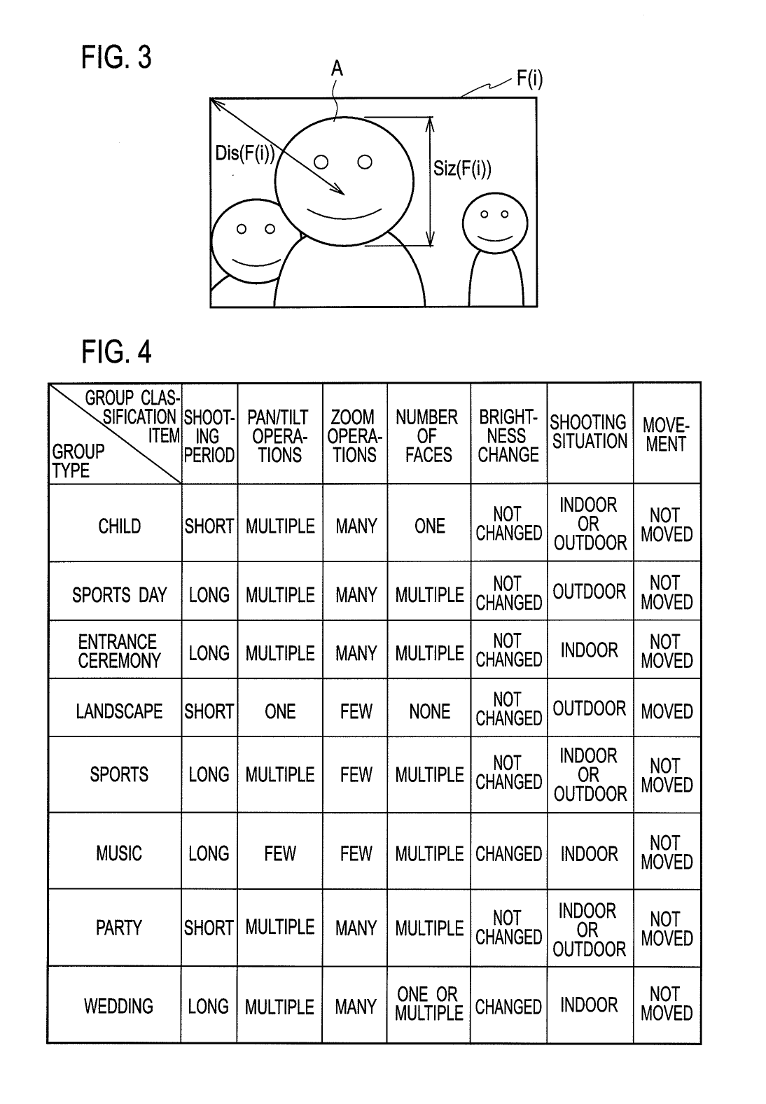

As shown in FIG. 3, Dis(F(i)) is the distance between the center of a face A which is the largest among the faces displayed in the representative frame F(i) and the upper left corner of the representative frame F(i), which is the closest of the 4 corners to the face A. Siz(F(i)) can be defined as the vertical length of the largest face A, for example. The representative frame F(i) shown in FIG. 3 includes three faces, and Num(F(i)) is then 3.

Moreover, the feature data can include zoom information including the zoom ratio at which the representative frame F(i) was shot or whether the representative frame F(i) was shot during a zooming operation. The zoom information needs to be recorded together with the image data in association with each frame when the frame is shot by a shooting device. That is, in terms of whether the shooting device is in zoom-in operation, whether the shooting device is in zoom-out operation, or the zoom ratio. Alternatively, the zoom information on the zoom-in and zoom-out operations may be acquired by an image analysis of plural frames in the feature analysis unit 24.

In addition, the frame feature data acquired by the feature analysis unit 24 can include shooting position, movement distance, rotation angle, image brightness, and light source type information as described below.

The shooting position information is information indicating the position of the shooting device which is shooting each scene. As for the shooting position, the position information needs to be acquired by a positioning system such as a global positioning system (GPS) and be recorded in the storage unit 3 together with the image data when each frame of the scene is shot by the shooting device. The feature analysis unit 24 then reads the recorded position information from the storage unit 3.

The movement distance information and rotation angle information include, respectively, the distance of movement of the shooting device from the previous representative frame in the three axial directions and the angle of rotation of the shooting device from the previous representative frame in the three axial directions. The movement distance and rotation angle information may be obtained in such a manner that physical amounts, such as acceleration, angular velocity, and inclination, which are detected by an acceleration sensor, a gyro sensor, or the like provided for the shooting device are recorded together with image data and the feature analysis unit 24 reads the recorded physical amounts. Alternatively, the movement distance and rotation angle information may be obtained by an analysis of image and audio in the feature analysis amount 24.

The image brightness information is an average of brightness of pixels of each representative frame which is obtained by image analysis in the feature analysis unit 24. The image brightness information may be set to the brightness of a part of the frame or may be set using hue of the frame. The image brightness information may be also selected from various values such as the F number of the optical system and an average brightness of pixels in each frame acquired by image analysis.

The light source type information is the type of the light source such as sunlight, incandescent lamps, various discharge lamps, and LED lamps. The light source type information can be acquired by analyzing the spectrum distribution of light detected by a photo sensor including an image pickup device of the shooting device. For example, the light source type information can be obtained by image analysis of each frame in the feature analysis unit 24.

As the feature data, in addition to the frame feature data, the feature analysis unit 24 can acquire scene feature data representing the features of each scene. The scene feature data can be selected from the shooting start time of the scene, the shooting end time thereof, the shooting period thereof, the shooting interval from the previous scene, and the like.

The group classification unit 25 classifies each group grouped by the grouping unit 23 to a particular group type based on the feature data acquired by the feature analysis unit 24. The names of the group types could be “Child”, “Sports day”, “Entrance ceremony”, “Landscape”, “Sports”, “Music”, “Party”, “Wedding”, and the like.

The group classification unit 25 uses the feature data to classify each group to one of the group types based on each group's assessment under a range of group classification items. As shown in FIG. 4, in the description of the embodiment, the group classification items are seven items including the “shooting period”, “number of pan/tilt operations”, “number of zoom operations”, “number of faces”, “brightness change”, “shooting situation”, and “movement”.

As for the “shooting period”, the group classification unit 25 calculates the average shooting period of the scenes included in each group. A group having an average “shooting period” value which is not less than a previously determined threshold is set to “long”, and a group having an average less than the threshold is set to “short”.

As for the “number of pan/tilt operations”, the group classification unit 25 sets as follows with reference to the angle of rotation of the shooting device. For a group in which the majority of scenes include two or more pan/tilt operation, the value of the “number of pan/tilt operations” is set to “multiple”. For a group in which the majority of scenes include only one panning or tilting operation, the value of the “number of pan/tilt operations” is set to “only one”. For a group in which the majority of scenes include no panning or tilting operation, the value of the “number of pan/tilt operations” is set to “few”.

As for the “number of zoom operations”, the group classification unit 25 calculates the number of zoom operations performed during shooting of each scene with reference to the zoom information and sets the value thereof as follows. A group in which the value of the “number of zoom operations” is not less than a predetermined threshold is set to “many”, and a group in which the “number of zoom operations” is less than the predetermined threshold is set to “few”. The number of zoom operations may include either zoom-in or zoom-out operations or may include both of zoom-in and zoom-out operations.

As for the “number of faces”, in the representative frames constituting each scene, the number of representative frames F1(i) in which the number Num of displayed faces is 1, the number of representative frames F2(i) in which the number Num of faces is 2 or greater, and the number of representative frames F0(i) in which the number Num of faces is 0 are counted. For a group in which the majority of scenes are of type F1(i), the group classification unit 25 sets the “number of faces” to “one”. In a similar manner, for a group in which the majority of scenes are of type F2(i), the “number of faces” is set to “multiple”, and for a group in which the majority of scenes are of type F0(i), the “number of faces” is set to “none”.

As for the “brightness change”, the group classification unit 25 counts the number of representative frames in each group where the difference in image brightness from the adjacent representative frame is not less than a predetermined threshold. A group in which the counted number of frames is not less than a predetermined number is set to “changed”, and a group in which the counted number of frames is less than the predetermined number is set to “not changed”. The difference in image brightness does not only include the difference in representative frames of one scene but also includes the difference between representative frames of two scenes.

As for the “shooting situation”, the group classification unit 25 determines whether each scene is shot indoor or outdoor with reference to the image brightness or the light source type. For a group in which the ratio of the number of scenes determined to be shot indoor to the number of scenes determined to be shot outdoor is within a predetermined range, the group classification unit 25 sets “shooting situation” to “indoor”. For a group in which the ratio thereof is higher than the predetermined range, the group classification unit 25 sets “shooting situation” to “outdoor”. In the case of determining the shooting situation of scenes from the image brightness, a scene having image brightness not less than a predetermined threshold is determined to be shot outdoor, and a scene having image brightness less than the threshold value is determined to be shot indoor.

As for the “movement”, the group classification unit 25 calculates the distance of movement between scenes from the positional information at the start of shooting of each scene and calculates the total distance of movement of each group. For a group having a total distance of movement not less than a predetermined threshold value the group classification unit 25 sets the value to “moved” and for a group having a total distance of movement less than the predetermined threshold value, the group classification unit 25 sets the value to “not moved”.

The group classification unit 25 determines the value for each group under each group classification item and classifies each group to one of the group types with reference to the group classification information 32 stored in the storage unit 3. As shown in FIG. 4, the group classification information 32 can be composed of a table that defines the values of the group classification items of each group type.

The group cut number determination unit 26 uses the total number Ac of cuts, which is determined by the total cut number determination unit 22, and determines the number Gc of cuts in each group. The number Gc of cuts is the number of cuts reproduced as a digest in each group. The group cut number determination unit 26 may determine the number Gc of cuts of each group as proportional to the total number of scenes included in the group, the total shooting period of the scenes included in the group, or the like. Alternatively, the number Gc(n) of cuts of the n-th group (n=1, 2 . . . , n) may be calculated by Equation (1).

$$Gc ( n ) = \frac{log ( L ( n ) ) \times log ( N ( n ) + 1 )}{{\sum }_{k = 1}^{g} ( log ( L ( k ) ) \times log ( N ( k ) + 1 ) )} \times Ac \qquad ( 1 )$$

In Equation (1), L(n) is the total time period of scenes of the n-th group, and N(n) is the number of scenes of the n-th group.

The group cut number determination unit 26 may determine the number Gc of cuts as proportional to the total time period of image sections including one face (Num continues to be equal to or more than 1) in the scenes of each group or as proportional to the total time period of image sections including no face (Num continues to be equal to 0).

The group cut number determination unit 26 may cause a user to select a desired shot content and determine the number Gc of cuts such that many cuts relating to the content selected by the user are included. To be specific, the group cut number determination unit 26 displays options representing the contents of shooting such as “select many active scenes” or “select landscape”. For example, when the “select many active scenes” is selected by the input unit 4 according to the user's operation, the group cut number determination unit 26 can determine the number Gc of cuts such that each group is classified to a group type corresponding to the selected option, such as “sports day” or “sports”.

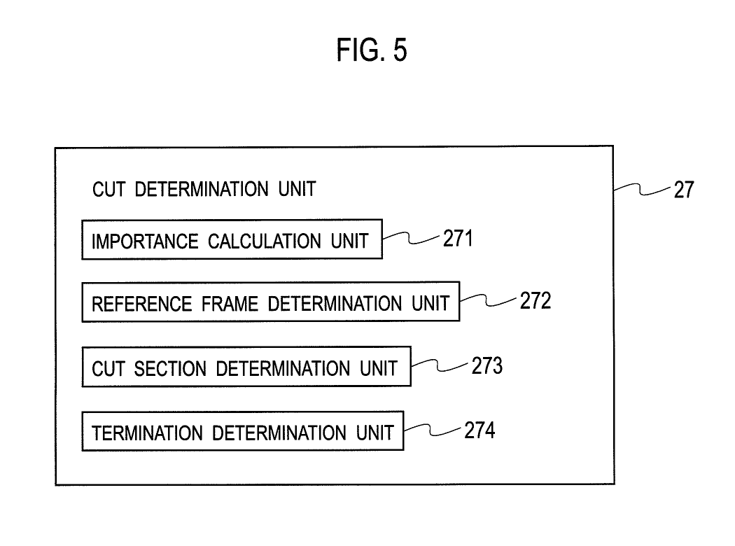

As shown in FIG. 5, the cut determination unit 27 includes an importance calculation unit 271, a referential frame determination unit 272, a cut section determination unit 273, and a termination determination unit 274 as a logical representation. The cut determination unit 27 determines the cuts in each group by a method determined for each group type.

The importance calculation unit 271 calculates the importance of each representative frame based on the feature data acquired by the feature analysis unit 24 by using a formula corresponding to each group type classified by the group classification unit 25. The importance calculation unit 271 can choose a formula so that the most suitable image sections including key characteristics of the group are given high importance for each group.

As for a group with the group type classified as “Child” by the group classification unit 25, the importance calculation unit 271 can use a formula that places high importance on a frame in which a large human face is displayed at the center. The importance calculation unit 271 calculates importance I(F(i)) of the representative frame F(i) using Equation (2) for a group whose group type is “Child”. In equations below, Maxnum, MaxDis, and MaxSiz are the maximum values of Num(F(i)), Dis(F(i)), and Siz(F(i)), respectively.

I(F(i))=10Siz(F(i))/MaxSiz+Dis(F(i))/MaxDis (2)

As for a group with the group type classified as “Party” by the group classification unit 25, the importance calculation unit 271 can use a formula that places high importance on a frame in which many human faces are displayed. The importance calculation unit 271 calculates importance I(F(i)) of the representative frame F(i) using Equation (3) for a group whose group type is “Party”.

I(F(i))=100Num(F(i))/MaxNum+10Dis(F(i))/MaxDis+Siz(F(i))/MaxSiz (3)

As for a group with the group type classified as “Landscape” by the group classification unit 25, the importance calculation unit 271 can use a formula that places high importance on a frame in which no human face is displayed. The importance calculation unit 271 calculates importance I(F(i)) of the representative frame F(i) using Equation (4) for a group whose group type is “Landscape”.

I(F(i))=MaxNum/Num+(F(i))MaxSiz/Siz(F(i)+MaxDis/Dis(F(i)) (4)

The referential frame determination unit 272 determines a number of referential frames Fb for each group where Fb is equal to as the number Gc of cuts, which is determined by the group cut number determination unit 26, based on the importance calculated by the importance calculation unit 271 using a formula corresponding to the group type. The referential frame Fb is a frame referenced for use as a cut.

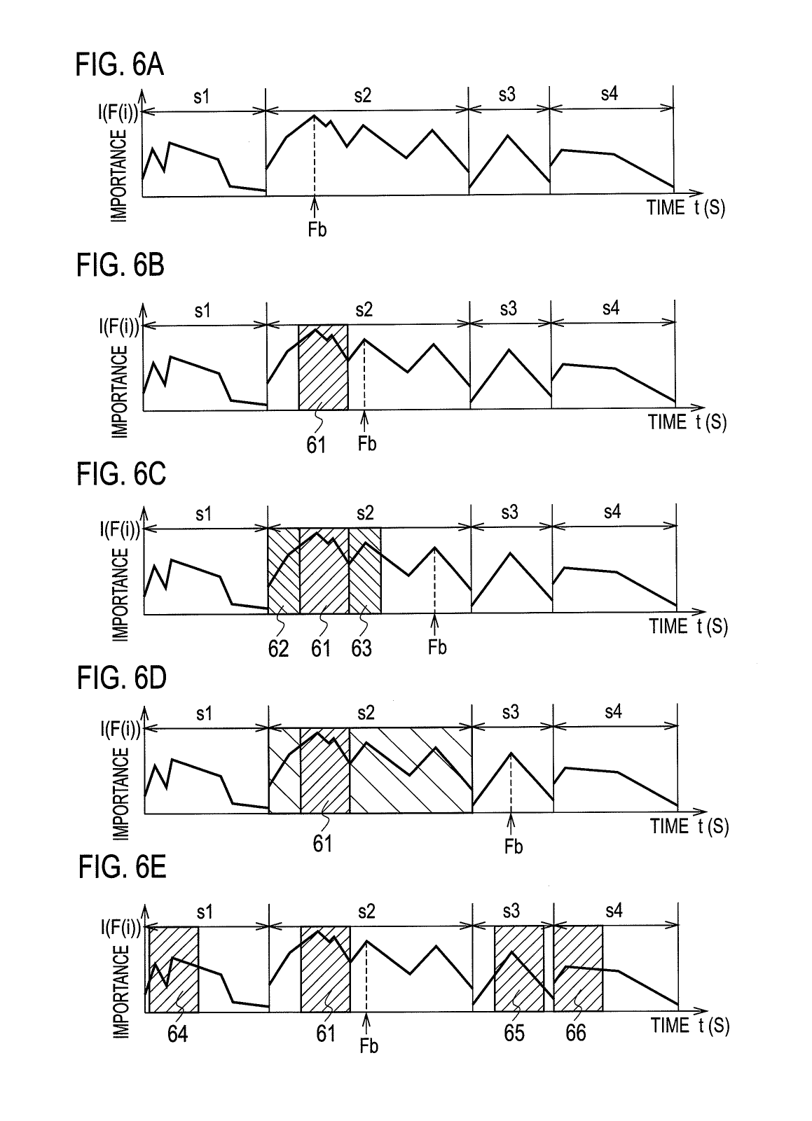

As shown in FIG. 6A, in a group composed of four scenes s1 to s4, the referential frame determination unit 272 can set the referential frame Fb to be the frame of the scene S2 at which the importance I(F(i)) calculated from the same calculation formula is the highest in the group.

In the case of determining plural cuts in a group, as shown in FIG. 6B, the referential frame determination unit 272 can determine a new referential frame Fb in addition to the already determined referential frame. In this case, the frame with the highest importance I(F(i)) is used from among the remaining frames, excluding a cut candidate section 61 which has already been determined as a cut. Moreover, the referential frame determination unit 272 can determine, as a new referential frame Fb, the frame with the highest importance I(F(i)) among the representative frames excluding the candidate section 61 plus predetermined sections before and after the same. As shown in FIG. 6C, the referential frame determination unit 272 determines as a new referential frame Fb, a representative frame with the highest importance among the representative frames other than the cut candidate section 61 already determined as a cut and sections 62 and 63 covering 30 seconds before and after the cut candidate section 61.

The referential frame determination unit 272 determines a new referential frame Fb from sections excluding the section already determined as the cut and the predetermined sections before and after the same. This can prevent inclusion plural similar cuts in the final digest. Accordingly, the digest can be determined efficiently.

The referential frame determination unit 272 may determine a new referential frame Fb excluding the scene including the section already determined as the cut so that only one cut is determined in each scene. As shown in FIG. 6D, in the case of determining a new referential frame Fb after the cut candidate section 61 is already determined from the scene s2, the referential frame determination unit 272 sets the new referential frame Fb to a representative frame with the highest importance in the scenes s1, s3, and s4 excluding the scene s2.

In the case of then further determining a new referential frame Fb after a cut is already determined in each of the four scenes s1 to s4, as shown in FIG. 6E, for example, the referential frame determination unit 272 may set the new referential frame Fb to a representative frame with the highest importance in the representative frames other than the four cut candidate sections 61 and 64 to 66 individually determined in the respective scenes s1 to s4. In FIG. 6D, all of scene s2 is set as an exclusion section where the new referential frame Fb is not to be determined. However, in the case of further determining a new referential frame Fb after determining a cut in each of the four scenes s1 to s4, only the cut candidate section 61 is set as the exclusion section, and a new referential frame Fb can be freely set anywhere other than the cut candidate section 61.

The cut section determination unit 273 determines a preliminary section p defined by the referential frame Fb determined by the referential frame determination unit 272 and the particular feature data corresponding to the group type and then determines the length of the section to be included in the cut before and after the referential frame Fb so that the section includes at least the determined preliminary section.

As for a group whose group type is “Child”, “Party”, or the like, the cut section determination unit 273 can use “the number of faces” as the feature data to set a preliminary section p as a section around the referential frame Fb in which a face is detected (section with Num(F(i))>=1). As for a group whose group type is “Landscape”, the cut section determination unit 273 can use “the number of faces” and “image brightness” as the feature data to set a preliminary section p as a section around the referential frame Fb where no face is detected and the brightness is not less than the threshold value.

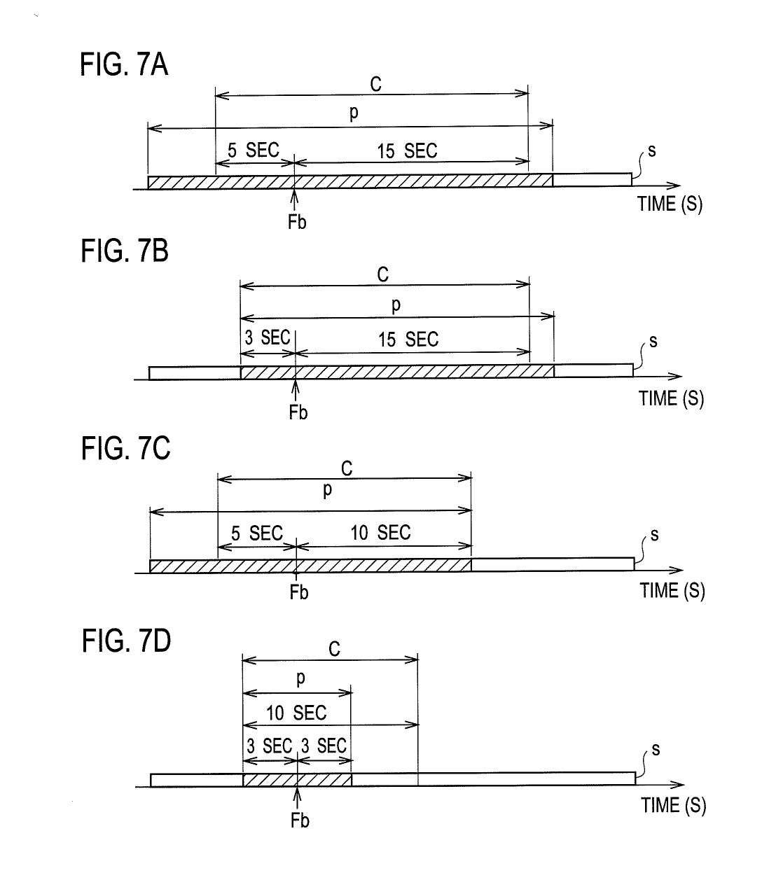

In the case of determining a cut, a section length of 20 seconds maximum around the referential frame Fb (5 seconds before and 15 seconds after the referential frame Fb) is chosen. As shown in FIG. 7A, the cut section determination unit 273 sets a cut C as a section totaling 20 seconds around the referential frame Fb (including 5 seconds before and 15 seconds after the referential frame Fb).

As shown in FIG. 7B, in the case where the preliminary section p before the referential frame Fb is only 3 seconds, that is, less than 5 seconds, the cut section determination unit 273 sets the cut C as a section totaling 18 seconds around the referential frame Fb (3 seconds before and 15 seconds after the referential frame Fb). As shown in FIG. 7C, in the case where preliminary section p after the referential frame Fb is only 10 seconds, that is, less than 15 seconds, the cut section determination unit 273 sets the cut C as a section totaling 15 seconds around the referential frame Fb (5 seconds before and 10 seconds after the referential frame Fb).

Moreover, if the length of the preliminary section p is less than a predetermined threshold value, the cut section determination unit 273 can increase the length of the cut section to a predetermined period of time. For example, as shown in FIG. 7D, in the case where the preliminary section p is 6 seconds in total (3 seconds before and after the referential frame Fb), that is, less than 10 seconds, the cut section determination unit 273 sets the cut C as a section of 10 seconds from the beginning of the preliminary section p.

The cut section determination unit 273 stores the digest information 33 that defines the determined cuts as image data in the storage unit 3.

In order to reproduce the digest, the digest reproduction unit 28 reads the digest information 33 stored in the storage unit 3 and displays the cuts as the digest image data of the image information 31, which are defined by the digest information 33, in chronological order on the display unit 5.

The digest target scene determination unit 21, total cut number determination unit 22, grouping unit 23, feature analysis unit 24, group classification unit 25, group cut number determination unit 26, cut determination unit 27, and digest reproduction unit 28 of the processing unit 2 shown in FIG. 1 are just a representative logical structure and the processing unit 2 maybe composed of different hardware processing devices.

### (Image Processing Method)

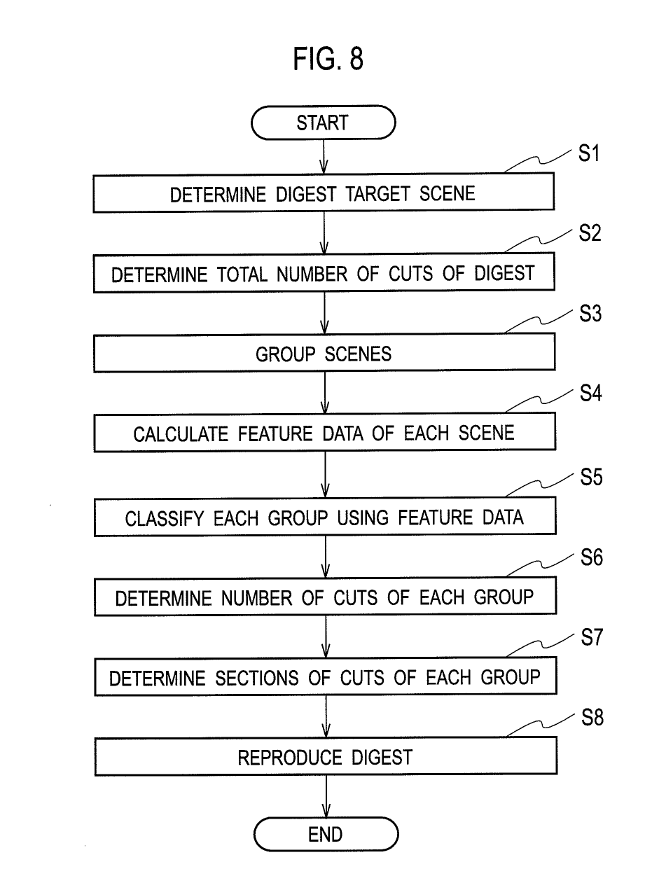

Using the flowchart of FIG. 8, a description is given of an image processing method according to the embodiment. The image processing method described below is an example applicable to the image processing apparatus according to the embodiment. It is certain that other various image processing methods are applicable to the image processing apparatus according to the embodiment.

First, in step S1, the digest target scene determination unit 21 reads the image information 31 from the storage unit 3 and determines the digest target scenes as candidate scenes which can be employed in the digest according to the information from the input unit 4.

In step S2, based on the information from the input unit 4 or the specified length of the digest, the total cut number determination unit 22 determines the total number Ac of cuts, which is the total number of cuts to be reproduced from the digest target scenes as the digest.

In step S3, the grouping unit 23 divides the plural digest target scenes into some groups based on the shooting intervals of the plural digest target scenes or the like.

In step S4, the feature analysis unit 24 selects plural representative frames from the frames constituting each digest target scene and acquires the feature data representing the features of scenes for each representative frame.

In step S5, the group classification unit 25 uses the feature data acquired by the feature analysis unit 24 to classify each group to one of a set group types based on each group's assessment under a range of group classification items. The group classification unit 25 reads the group classification information 32 from the storage unit 3 and determines the value of each group under each group classification item and classifies each group to one of the group types with reference to the group classification information 32 stored in the storage unit 3.

In step S6, the group cut number determination unit 26 uses the number Ac of cuts, which is determined by the total cut number determination unit 22, and based on the total number of scenes included in the group, the total time period of the scenes, or the like, determines the number Gc of cuts which is the number of cuts to be reproduced as the digest for each group.

In step S7, the cut determination unit 27 determines, for each group, a number of sections to be used as cuts, the number being equal to the number Gc of cuts, which is determined by the group cut number determination unit 26 for each group, which is classified by the group classification unit 25 into any of the group types. The cut determination unit 27 stores the information defining each cut for the digest target scenes as the digest information 33 in the storage unit 3.

In step S8, the digest reproduction unit 28 reads the digest information 33 stored in the storage unit 3 and displays the cuts as the digest image data from the image information 31 stored in the storage unit 3, in chronological order on the display unit 5 to reproduce the digest, and the process is terminated.

### (Details of Process for Cut Determination Unit 27)

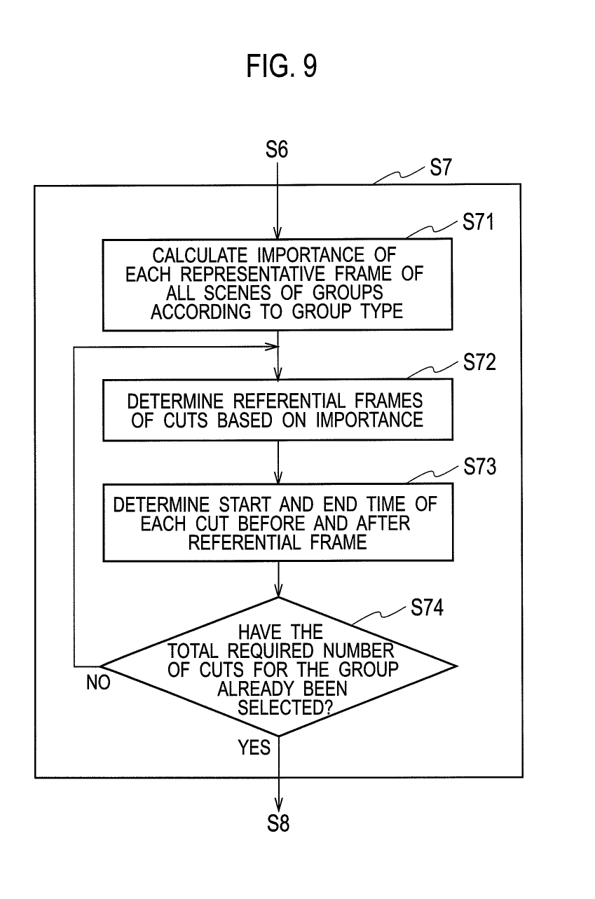

Using the flowchart of FIG. 9, a description is given of the details of the step S7 of the aforementioned flowchart of FIG. 8 with reference to FIGS. 6 and 7 as an example.

First, in step S71, the importance calculation unit 271 calculates the importance I(F(i)) of each representative frame of all the scenes included in each group based on the feature data acquired by the feature analysis unit 24 using a formula corresponding to each of the groups classified by the group classification unit 25.

Next, in step S72, the referential frame determination unit 272 determines the referential frame Fb as a referential frame for each cut based on the calculated importance I(F(i)). When the process of the step S72 is performed for the first time, the referential frame determination unit 272 can select a representative frame of the highest importance I(F(i)) in each group as shown in FIG. 6A as the referential frame Fb.

In step S73, the cut section determination unit 273 determines the starting and ending times of each cut before and after the referential frame Fb to define the cut for the digest target scene. The cut section determination unit 273 stores the information defining cuts for the digest target scene as the digest information 33 in the storage unit 3.

In step S74, with reference to the number of cuts selected thus far and the required number Gc(n) of cuts, which is determined by the group cut number determination unit 26, the termination determination unit 274 determines whether the required number Gc(n) of cuts has been selected for each group. If the termination determination unit 274 determines for each group that the required number Gc(n) of cuts has not yet been selected, the process returns to the step S72, and the referential frame determination unit 272 determines the next new referential frame Fb. If the termination determination unit 274 determines for each group that the required number Gc(n) of cuts already been reached, the cut determination unit 27 terminates the process at the step S7.

With the image processing apparatus according to the embodiment, the scenes divided into each group are automatically classified to a particular group type based on the feature data acquired from the image information, and the sections to be reproduced as a digest are set to appropriate sections by a method corresponding to each group type. Accordingly, it is possible to provide an image processing apparatus, an image processing method, and an image processing program which are capable of efficiently creating a digest for each type of image with a simple structure.

### Other Embodiments

It should not be understood that the description and drawings of the above-described embodiment will limit the present invention. From this disclosure, various substitutions, examples, and operation techniques will be apparent to those skilled in the art.

In the already-described embodiment, the image processing apparatus is applicable to image summary creation of TV programs and the like when the feature data can be acquired by image analysis of scenes.

In the already-described embodiment, the order of steps of the image processing method is not limited to the order described using the flowchart of FIG. 8. It is possible to omit some of the steps of the image processing method, change the order of the steps, or make any other change as needed. The determination of the total number Ac of cuts in the step S2 may be performed before the step S1.

It is certain that in addition to the aforementioned configurations, the present invention includes various embodiments or the like not described herein, such as other configurations to which the above-described embodiment is can be applied. Accordingly, the technical scope of the present invention is determined only by the features of the invention according to claims appropriated from the above description.

What is claimed is:

1. An image processing apparatus, comprising:
a feature analysis unit configured to acquire feature data from image included in each of a plurality of scenes which is continuous image information from the start to the end of shooting, the feature data representing the feature of the scene;
a group classification unit configured to classify a group as a set of scenes taken from the plurality of scenes into any one of a plurality of group types based on the feature data of the scenes included in the group;
a cut determination unit configured to calculate importance from the feature data of the scenes included in the group using a formula corresponding to the group type to which the group is classified and determine cuts from the group based on the importance, the cuts being image to be reproduced; and
a digest reproduction unit configured to reproduce the cuts.

2. The image processing apparatus according to claim 1, wherein p1 each of the scenes includes a plurality of frames,
the feature analysis unit acquires the feature data from each of the plurality of frames,
the group classification unit determines the feature of
the group based on the feature data of the plurality of frames of the scenes included in the group and determines the group type based on the features of the group, and
the cut determination unit uses a formula corresponding to the group type to calculate the importance of each frame based on the feature data of the frame and determines the cuts to be selected from the group based on the importance.

3. The image processing apparatus according to claim 2, wherein the cut determination unit includes:
a referential frame determination unit configured to, based on the importance, determine a referential frame in the group, the referential frame being a frame used to determine a section for the cut; and
a section determination unit configured to determine a preliminary section including the referential frame, the preliminary section being determined by the particular feature data corresponding to the group type and to determine a section to be the cut including at least the preliminary section.

4. The image processing apparatus according to claim 2, further comprising:
a cut number determination unit configured to determine the number of cuts in the group, wherein
the referential frame determination unit determines a number of referential frames equal to as the number of required cuts determined by the cut number determination unit for each of the scenes included in the group, and
the cut determination unit selects image sections which include the referential frames to be used as the cuts.

5. The image processing apparatus according to claim 2, wherein
the referential frame determination unit sets a frame of the highest importance in the group as a first referential frame and after excluding an image section including the first referential frame selects a frame of the next highest importance in the group as a second referential frame, and
the cut determination unit determines as the cuts, image including the first referential frame and image including the second referential frame.

6. The image processing apparatus according to claim 2, wherein
each group type is set by a combination of classification items based on the plurality of feature data,
the group classification unit determines the values of the classification items based on the feature data of the group, and
classifies the group to any one of the plurality of group types.

7. An image processing method, comprising:
acquiring feature data from image included in each of a plurality of scenes which is continuous image information from the start to the end of shooting, the feature data representing the features of each scene;
classifying a group as a set of scenes taken from the plurality of scenes into any one of a plurality of group types based on the feature data of the scenes included in the group;
calculating importance from the feature data of the scenes included in the group using a formula corresponding to the group type to which the group is classified;
determining cuts from the group based on the importance, the cuts being image to be reproduced; and
reproducing the cuts.

8. The image processing method according to claim 7, further comprising the steps of:
acquiring the feature data from the plurality of frames,
determining the features of the group based on the feature data of the plurality of frames of the scenes which are included in the group and determining the group type based on the features of the group,
calculating the importance of each frame based on the feature data of the frame using a formula corresponding to the group type and
determining the cuts to be selected from the group based on the importance.

9. An image processing program, wherein the image processing program is stored in a non-transitory computer-readable recording medium executed by a computer, comprising:
acquiring feature data from image included in each of a plurality of scenes which is continuous image information from the start to the end of shooting, the feature data representing the features of each scene;
classifying a group as a set of scenes taken from the plurality of scenes into any one of a plurality of group types based on the feature data of the scenes included in the group;
calculating importance from the feature data of the scenes included in the group using a formula corresponding to the group type to which the group is classified and determine cuts from the group based on the importance, the cuts being image to be reproduced; and
reproducing the cuts.

10. The image processing program according to claim 9, further comprising:
acquiring the feature data from the plurality of frames,
determining the features of the group based on the feature data of the plurality of frames of the scenes which are included in the group and determine the group type based on the feature of the group,
calculating the importance of each frame based on the feature data of the frame using a formula corresponding to the group type and
determining the cuts to be selected from in the group based on the importance.
